(19) United States
(12) Patent Application Publication
(10) Pub. No.: US 2013/0290619 A1
(43) Pub. Date: Oct. 31, 2013

(54) Apparatus and Method for Sequential Operation on a Random Access Device

(71) Applicant: Frederick Knight, Cary, NC (US)

(72) Inventor: Frederick Knight, Cary, NC (US)

(73) Assignee: NetApp, Inc., Sunnyvale, CA (US)

(21) Appl. No.: 13/459,974

(22) Filed: Apr. 30, 2012

(51) Int. Cl. G06F 12/00

(52) U.S. Cl. 711/104; 711/E12.001

(57) ABSTRACT

The present disclosure involves a method. As a part of the method, a logically sequential range of memory blocks is allocated for sequential access. A pointer is initialized with an address of a first memory block that is within the range of the memory blocks. In response to a data write next request, data is written into the range of the memory blocks, starting with the first memory block and continuing sequentially in subsequent memory blocks within the range until the data write next request is completed. Thereafter, the pointer is updated based on a last memory block in which data is written.

### TECHNICAL FIELD

The present description relates, in general, to network storage systems and, more specifically, to techniques of writing data sequentially on a random access storage device.

### BACKGROUND

A computer data storage system provides data storage and retrieval services. A data storage system frequently uses storage mechanisms such as disks or tapes to back up the desired data. In that regard, disks are typically random access devices, since they provide the capability to access an element at any arbitrary position in a sequence. Therefore, data can be written or read from any arbitrary address on the disk. On the other hand, tapes are considered sequential access devices, meaning that data on a tape must be accessed according to a specific sequence. For example, new data written to the tape is appended after the previously-written data, and data on the tape must be retrieved in a sequential manner.

Recently, logging file systems have been introduced in which a sequential stream of information is written to, or read from, a log. Even when the log is written to a random access memory storage device such as a disk, the stream of information (e.g., a video) is still written in a sequential manner to a list of memory blocks. When the log is ready to be processed, the information stored is read back sequentially again. In other words, there is no need to access the log in a random access manner. In any event, conventional data storage systems that have multiple clients accessing a storage mechanism may employ a negotiation technique among the clients. Such negotiations between the clients are performed to avoid data loss, for example data loss caused by data from different clients being written to the same memory locations. However, these negotiations are cumbersome for the clients and may be time consuming.

Therefore, while conventional storage systems have been generally adequate for their intended purposes, they have not been entirely satisfactory in all respects.

### BRIEF DESCRIPTION OF THE DRAWINGS

The present disclosure is best understood from the following detailed description when read with the accompanying figures.

FIG. 1 is a simplified block diagram of an example network storage system that may implement various techniques according to the embodiments disclosed herein.

FIG. 2 is a simplified flowchart of an example method for performing a sequential data writing operation according to the embodiments disclosed herein.

FIG. 3 is a simplified flowchart of another example method for performing a sequential data writing operation according to the embodiments disclosed herein.

FIG. 4 is a simplified block diagram of a computer system for implementing the various devices of a network storage system according to the embodiments disclosed herein.

### SUMMARY

Various embodiments include systems, methods, and computer program products for implementing sequential operations on a random access device.

One of the broader forms of the present disclosure involves a method. The method includes allocating a logically sequential range of random access memory blocks for sequential access. A pointer is initialized with an address of a first memory block that is within the range of the memory blocks. In response to a data write next request, data is written into the range of the memory blocks, starting with the first memory block and continuing sequentially in subsequent memory blocks within the range until the data write next request is completed. Thereafter, the pointer is updated based on a last memory block in which data is written.

In some embodiments, the method further includes: returning, upon a completion of the data write next request, a completion status for the data write next request, wherein the completion status indicates the address of the first memory block in which data is written.

In some embodiments, the random access memory blocks reside on a storage device of a logical unit.

In some embodiments, the allocating is performed by a device server in response to an allocation request from a client of a network storage array, wherein the device server and the storage device are components of the network storage array.

In some embodiments, the allocating is implemented at a time when the storage device is physically fabricated.

In some embodiments, the allocating is performed at a time when the logical unit is created by a management application from a client of a network storage array.

In some embodiments, the data write next request comprises a first data write next request, and wherein the last memory block in which the data is written is known as a previous last memory block; and the method further includes: writing, in response to a second data write next request, additional data sequentially into the range of the memory blocks, starting with a memory block that is addressed immediately after the previous last memory block and ending with a new last memory block.

In some embodiments, the method further includes: updating the pointer again based on the new last memory block after the writing the additional data.

In some embodiments, the first data write next request and the second data write next request are sent from different clients of a network storage array.

Another of the broader forms of the present disclosure involves apparatus comprising a non-transitory, tangible machine-readable storage medium storing a computer program. The computer program contains machine-readable instructions that when executed electronically by processors, perform: reserving a group of logically contiguous random access memory blocks on a storage device for sequential access. The instructions also perform: assigning, to a pointer, an address of a first memory block of the group of memory blocks. The instructions also perform: performing a first data write next operation that includes writing data into a first subset of the memory blocks, starting with the first memory block and continuing sequentially until all the data has been written. The instructions also perform: assigning, to the pointer, an address of a second memory block that is sequentially immediately after a last memory block of the first subset. The instructions also perform: performing a second data write next operation that includes writing additional data into a second subset of the memory blocks, starting with the second memory block and continuing sequentially until all the additional data has been written. The instructions also perform: assigning, to the pointer, an address of a third memory block that is sequentially immediately after a last memory block of the second subset.

In some embodiments, the computer program further comprises instructions for: returning, upon a completion of the first data write next operation, a first completion status for the first data write next operation; and returning, upon a completion of the second data write next operation, a second completion status for the second data write next operation. The first completion status and the second completion status include the addresses of the first memory block and the second memory block, respectively.

In some embodiments, the instructions for the reserving comprise instructions for reserving the group of the logically contiguous random access memory blocks for sequential access in response to a request from a client.

In some embodiments, the first data write next operation is performed in response to a first write next command from a first client; and the second data write next operation is performed in response to a second write next command from a second client.

Another of the broader forms of the present disclosure involves a network storage system. The network storage system includes one or more storage devices that each contain a plurality of memory blocks. The one or more storage devices are represented by a logical unit. In some embodiments, the memory blocks are configured for random access. In some other embodiments, the memory blocks are configured for sequential access. The network storage system also includes one or more device servers that manage data access to the logical unit. The device server executes code to perform: setting a pointer to point to an address of a first memory block of a logically contiguous subset of the randomly accessible memory blocks. The subset of the memory blocks has been designated for sequential access. The device server also executes code to perform: writing, in response to a write next command issued by a client communicatively coupled to the network storage system, an amount of data into the subset of memory blocks, starting with the first memory block and continuing sequentially until the amount of data has been written in its entirety. The device server also executes code to perform: updating the pointer to point to an address of a memory block that comes logically immediately after a last memory block in which the amount of data is written.

In some embodiments, the subset of the memory blocks is designated for sequential access during a manufacturing of the one or more storage devices.

In some embodiments, the subset of the memory blocks is designated for sequential access by a management application from the client or by the device server in response to a designation request from the client.

In some embodiments, the device server executes code to further perform: reporting, after the writing, to the client an address of the first memory block.

In some embodiments, the device server executes code to further perform: writing, after a completion of the write next command and in response to a further write next command, an amount of additional data into the subset of memory blocks, starting with the memory block pointed to by the pointer and continuing sequentially until the amount of additional data has been written in its entirety.

In some embodiments, the device server executes code to further perform: updating the pointer to point to an address of a memory block that comes logically immediately after a last memory block in which the additional data is written.

In some embodiments, the further write next command is issued by a further client communicatively coupled to the network storage system.

Yet one more of the broader forms of the present disclosure involves a method of writing data to a network storage system having random access media that is shared by a plurality of other clients. The method includes issuing a request to write data to a portion of the network storage system. The portion of the network storage system in which data is written is configured for sequential access. The request is issued without consultation with the other clients that shares access to the network storage system. The method includes receiving a response indicating an address to which the data is written. The method includes retrieving the data using the address.

In some embodiments, the method further includes: before the issuing the request, asking the network storage system to reserve the portion of the network storage system for sequential access.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

It is understood that various embodiments may be implemented in any kind of network environment. For example, some embodiments may be implemented in a TCP/IP network connecting multiple clients and multiple servers. Other embodiments may be implemented in more specialized environments, such as in a Network Attached Storage (NAS), a Storage Area Network (SAN), or any other network storage configuration. Various embodiments are not limited to any particular network architecture or purpose and may be adapted for use in a wide-ranging array of environments. While some of the concepts of the present disclosure are illustrated with respect to SAN, it is understood that the concepts may also apply to NAS as well.

Network storage systems have utilized various types of random access devices (e.g., hard disk drives, solid state drives) and sequential access devices (e.g., tape drives) to store data. For random access devices, using a specified memory address, data can be written to, and read from, any arbitrary location of the storage device corresponding to that memory address. In comparison, for sequential access devices, data is written and read in sequential order, starting from the beginning of a specified memory address. Traditionally, the random access devices have been configured only for random access, and the sequential access devices have been configured only for sequential access. These rigid configuration schemes limit the versatility and flexibility of network storage systems.

The present disclosure introduces a network storage system that not only combines the features and functionalities of both random access and sequential access devices, but also facilitates memory operations in a multi-client shared-storage context, for example by eliminating or reducing multi-client negotiations. According to one aspect of the present disclosure, a portion of a random access storage device of the network storage system is allocated for sequential access. By issuing a sequential write command (for example the SCSI command WRITE NEXT that is discussed in more detail below), one or more clients of the network storage system may write data to the portion of the network storage system that is allocated for sequential access. The network storage system maintains a pointer that keeps track of how much of the network storage system has been written by data associated with a previous sequential write operation. The pointer also indicates where in the network storage system a subsequent sequential write operation should begin. Upon a successful completion of a sequential write operation, the network storage system informs the client (that issued the sequential write command) where its data is written, so that the client can retrieve the data later.

Based on the above discussions, it can be seen that the present disclosure is particularly beneficial in architectures where multiple clients share the same network storage system. The clients need not negotiate with one another as to where their respective data should be written. Rather, they simply write data through the sequential write command, and the storage system can manage the data writing operations in a sequential manner through the maintenance of the pointer. Thus, data associated with different sequential write operations are automatically appended after one another in the portion of the storage system allocated for sequential access. Some example implementations of the present disclosure will now be discussed in more detail.

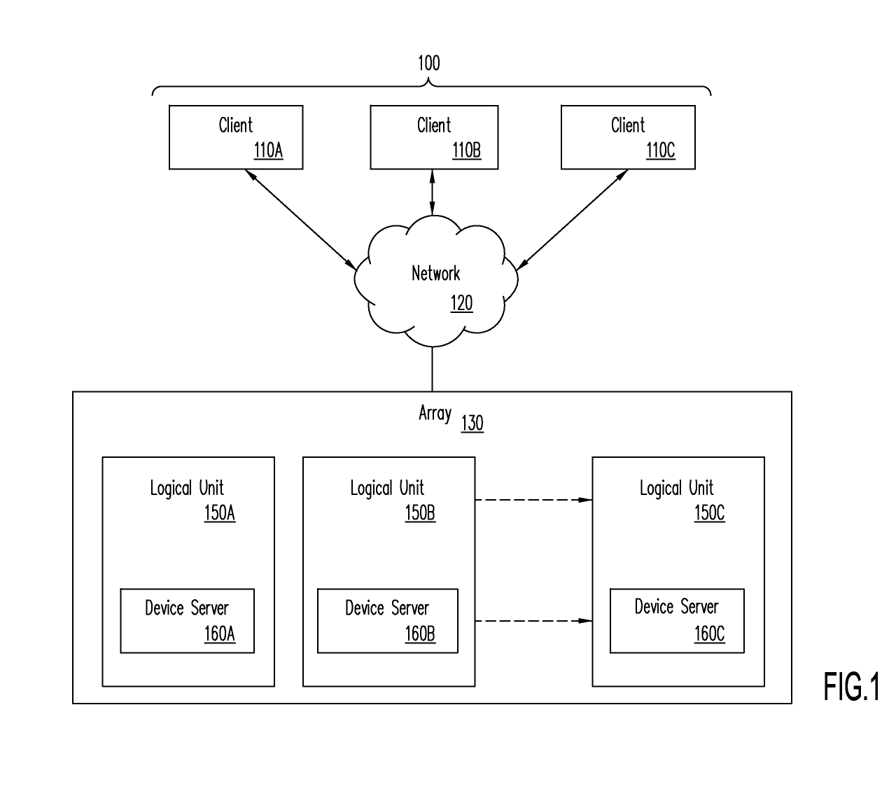

FIG. 1 is an illustration of an example network storage architecture 100 implementing a storage operating system in which the various aspects of the present disclosure may be applied. The network storage architecture 100 is shown as an example only. Other types of hardware and software configurations may be adapted for use according to the features described herein.

Referring to FIG. 1, the network storage system includes one or more clients 110 (also referred to as application clients or hosts). Each of the clients 110 may include, for example, a personal computer (PC), server computer, a workstation, handheld computing/communication device or tablet, and/or the like. FIG. 1 shows three clients 110A-C as examples, but the scope of the embodiments can include any appropriate number of clients. In some embodiments, one or more of clients 110 may act as a management station. Such client 110 may include management application software that is used by a network administrator to configure a storage array (discussed in more detail below) and to perform other management functions related to the storage network, such as scheduling backups, creating logical units for SAN use, setting user access rights, and the like.

The network storage architecture 100 also includes a network 120. The network 120 may include, for example, a local area network (LAN), wide area network (WAN), the Internet, a Fibre Channel fabric, a wireless network, or any combination of such interconnects. The clients 110 are communicatively coupled to the network 120.

The network storage architecture 100 further includes an array 130 (also referred to as a network storage array). The array 130 may include an array of storage media that is housed within an enclosure such as a box. In some embodiments, the storage media includes an array of storage devices configured for random access. In other embodiments, the storage media may include storage devices configured for sequential access. The array 130 may also include other suitable hardware components such as computer processors (e.g., a central processing unit or CPU), memory, cache, and/or suitable input/out mechanisms. The array 130 is communicatively coupled to the network 120 and may communicate with the clients 110 through the network 120.

The storage devices (e.g., hard disk drives, solid state drives, or other kinds of storage media) within the array 130 are configured in a manner such that they are presented as one or more logical units 150. A logical unit in this example includes a virtual object or virtual entity that is “seen” by the clients 110. For example, suppose the array 130 contains ninety physical random access storage devices. The ninety random access storage devices may be configured into thirty client-visible logical units 150. Each logical unit 150 is made up of three of the physical random access storage devices.

From the point of view of the clients 110, it is as if each logical unit 150 is a single random access storage device. When the client 110 writes data to the logical unit 150, the data may actually get spread across the different storage devices within the logical unit. This aspect of virtualization simplifies the communication process between the clients 110 and the array 130. It is understood that although three random access storage devices are used as an example herein, any other number of storage devices may be configured together as a single logical unit 150, and that the storage devices may be configured for random access or sequential access. In some embodiments, a single storage device may be presented as a plurality of logical units 150 as well.

Still referring to FIG. 1, the array 130 includes one or more logical units 150 that contain device servers 160. In a SCSI context, there is a one-to one correspondence between the logical units 150 and the device servers 160, meaning that each logical unit 150 contains a respective device server 160. However, it is envisioned that in other implementation contexts or protocol, there may be a different correspondence between and a different relationship between the logical units 150 and the device servers 160. For example, there may be more than one device server per logical unit, or a group of logical units may share a device server. Referring back to the example shown in FIG. 1, when the clients 110 make data writing requests to the array 130, such requests are handled by the device server 160. According to the various aspects of the present disclosure, a WRITE NEXT type of data write request is implemented to allow for sequential logic access to a range of random access blocks on a storage device.

In some embodiments, the WRITE NEXT data write request is in the form of a Small Computer System Interface (SCSI) command. The WRITE NEXT SCSI command writes data to the next set of available sequential locations on a random access storage device, for example the random access storage devices of the logical units 150. Upon successful completion of the writing request, the command reports back an address of the memory block (or a logical memory block) for which the operation was performed. In this manner, a group of memory blocks on a random access storage device may be accessed in a logically sequential manner.

One or more “next write” pointers are used to accomplish the WRITE NEXT command. A “next write” pointer is maintained by each device server 160 for each range of logical blocks that has been established for sequential operation. In more detail, each logical unit 150 may contain a plurality of regions that are made up of logical blocks (or memory blocks), where each region is designated for independent sequential access. For example, a logical unit may include a first region that contains logical blocks 100-10,000 and a second region that contains logical blocks 10,001-20,000. Both the first region and the second region are independent sequential access regions, and a respective “next write” pointer is maintained by the device server 160 for each of the first region and the second region.

A WRITE NEXT command that writes data into the first range would reference the “next write” pointer that is associated with the first range, and a WRITE NEXT command that writes data into the second range would reference the “next write” pointer that is associated with the second range. When a data writing request is received from a client 110, the value of the “next write” pointer is initially set to the address of the first memory block in which the data is supposed to be written. A WRITE NEXT command would begin by writing data to the memory block that is pointed to by the “next write” pointer, and continuing to write data to the subsequent memory blocks sequentially.

When the WRITE NEXT command is completed, the address of the starting memory block (in which data is written) is returned to the client that sent the data writing request, so that the client would be aware of where its data resides for future access. The device server 160 updates the value of the “next write” pointer for that range to reflect the address of the memory block of the next location for a subsequent WRITE NEXT operation in that range. The device server 160 also utilizes a set of management commands (issued by the clients 110) in conjunction with the WRITE NEXT command to perform the sequential data writing in a random access device. These management commands will also be discussed in more detail below.

If multiple WRITE NEXT commands to the same sequential region are received concurrently from different clients 110, the data from each client 110 would be written sequentially by the device server 160 into that sequential region. The device server 160 then responds to each completed WRITE NEXT command by returning to each respective client 110 the address of the starting memory block in which its data was written, so that each client 110 would know the starting location and the length of the data it wrote for future read access. According to the various aspects of the present disclosure, the write length (i.e., the length of the data and how many memory blocks the data will occupy) is known when the WRITE NEXT command is issued/received. Thus, as a performance optimization, space on the storage device could be pre-allocated for each concurrent WRITE NEXT operation, and the data could be processed for each concurrent WRITE NEXT command into their own locations.

To illustrate the above discussions with more clarity, an example data writing scenario involving the WRITE NEXT command is discussed below with reference to the components of FIG. 1. Suppose that the client 110A wishes to write data to the array 130, for example to one of the logical units 150. In order to carry out the data writing, the client 110A communicates with the device server 160. The client 110A may first issue a READ CAPACITY management command to the device server 160 to find out if, and what, the sequential access capabilities are for the array 130. Essentially, the client 110A is asking the device server 160 how big (capacity-wise) the logical unit 150 is in terms of its random and sequential access capabilities. In response to the READ CAPACITY command, the device server 160 will inform the client 110A as to how many memory blocks of the logical unit 150 is randomly accessible, and how many memory blocks of the logical unit 150 is sequentially accessible.

The client 110A may then configure the logical unit 150 to establish a group of memory blocks as being contiguously or sequentially accessible. This may be done through another management command SET SEQUENTIAL RANGES, which specifies how much data is to be written into each group (i.e., how many memory blocks the data will consume) of logical blocks on the logical unit 150. Alternatively, a group of logically contiguous memory blocks can be configured to be randomly accessible by the management application software from the client 110A, or even at a time of manufacture—when the storage devices of the logical unit 150 are physically fabricated.

The client 110A then issues a WRITE NEXT command to the device server 160. The WRITE NEXT command requests data to be logically sequentially written in one of the sequential accessible groups defined by the SET SEQUENTIAL RANGES command described above of a storage device of the logical unit 150. The device server 160 will control the WRITE NEXT operation, and will write data into the logical unit 150 starting from the memory block whose address corresponds to the “next write” pointer, and continuing sequentially thereafter until the WRITE NEXT operation has been completed (i.e., when all the data has been written). The “next write” pointer is maintained by the device server 160. The “next write” pointer has a value that corresponds to an address of a memory block. When the WRITE NEXT operation is completed, the device server 160 updates the value of the “next write” pointer to a new value, which is the address of the memory block that comes immediately after the last memory block in which data is written.

As an example, suppose the client 110A wishes to write 20 memory blocks worth of data into the logical unit 150. Suppose also the current value of the “next write” pointer is 10, meaning that the “next write” pointer is pointing to the memory block whose address is 10. Thus, the WRITE NEXT operation will write the data into the logical unit 150, starting from the memory block whose address is 10 and continuing sequentially until the memory block whose address is 29 has been written. In other words, data is written into 20 contiguous memory blocks: memory blocks 10, 11, 12 . . . 29.

After data has been written into the last memory block—the memory block 29—the device server 160 updates the value of the “next write” pointer to the address of the memory block that comes after memory block 29, which is memory block 30. Stated differently, the “next write” pointer now points to the memory block 30. This value of the “next write” pointer will be used for a subsequent WRITE NEXT data writing request. As the WRITE NEXT operation finishes, the address of the memory block 10—the first memory block in which data is written and also the previous value of the “next write” pointer—is returned to the client 110A, so that the client 110A will know where its data is stored for future access. Note that each logical unit 150 has a “next write” pointer for each group of its logically sequential ranges, and these pointers are maintained by the respective device server 160.

Suppose now that the client 110B wishes to write 40 memory blocks worth of data into the same logical unit 150 of the array 130. The client 110B can issue a WRITE NEXT command to the device server 160 in a similar manner as described above in association with the client 110A. Since the “next write” pointer is now pointed at the memory block 30, this is where the data will first be written. Once again, the 40 memory blocks worth of data is written into the logical unit in a logically sequential manner, starting with the memory block 30 and ending at the memory block 69.

When the WRITE NEXT operation initiated by the request from the client 110B has been completed, the device server 160 updates the “next write” pointer to a new value that is the address of the memory block 70. Alternatively stated, the “next write” pointer is now pointing at the memory block 70 at the end of the WRITE NEXT operation from the client 110B. Also, the address of the memory block 30—the previous value of the “next write” pointer—is returned to the client 110B.

If a client 110 wishes to find out about a current value of the “next write” pointer at any given time, it can issue a REPORT SEQUENTIAL RANGES management command to the device server 160. This command will notify the client 110 what memory block is currently being pointed by the “next write” pointer.

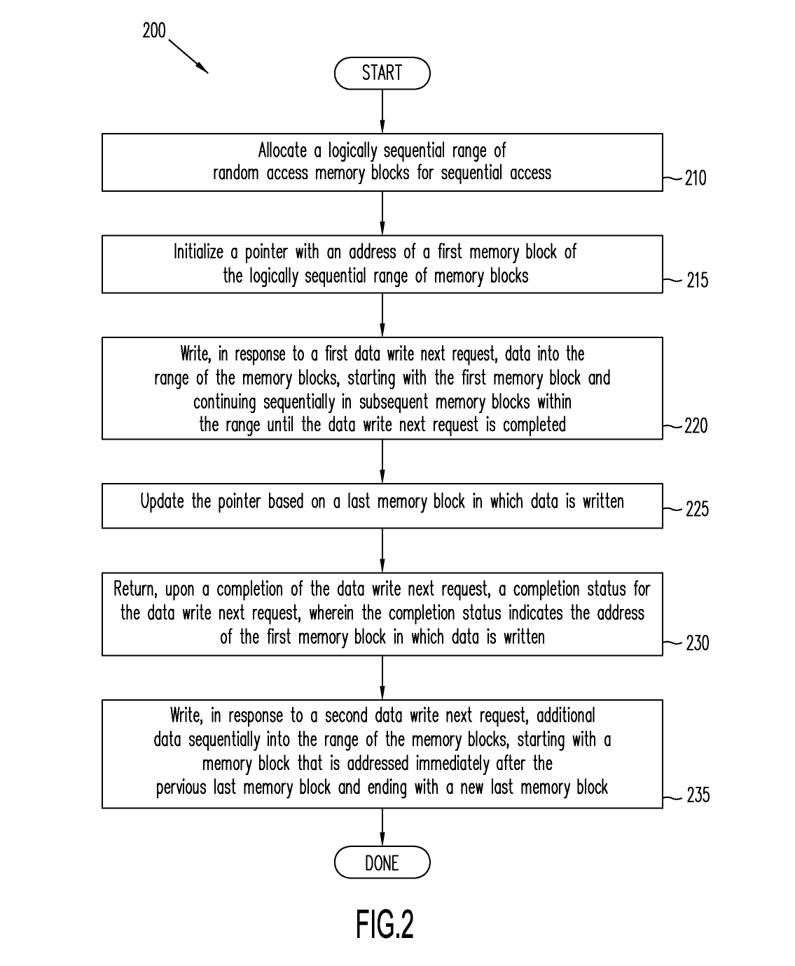

FIG. 2 is a flowchart of a method 200 for performing a sequential data writing command as well as its “setup” sequence according to various aspects of the present disclosure. In various embodiments, a device server (such as the device server 160 of FIG. 1) performs the actions of the method 200 as it provides an example sequential write command from a client. Also, though FIG. 2 is an example that focuses on a proposed SCSI command, WRITE NEXT, it is understood that the scope of embodiments includes any sequential write request compatible with the concepts herein, for any protocol now known or later developed. For example, the concepts disclosed herein may be applied to implement a similar command or operation for a Network File System (NFS) protocol, a Command Internet File System protocol, or another suitable protocol.

The method 200 includes a step 210, in which a range of logically sequential random access memory blocks is allocated for sequential access. The random access memory blocks reside on a storage device of a logical unit. In some embodiments, the memory blocks are allocated by a device server of a network storage system in response to an allocation request from a client of the network storage system. In other embodiments, the memory blocks are allocated at a time when the storage device is physically fabricated. In yet other embodiments, the memory blocks are allocated at a time when the logical unit is created by a management application from a client. Any acceptable technique for allocating the memory blocks may be used in various embodiments.

The method 200 includes a step 215, in which a pointer is initialized with an address of a first memory block of the logically sequential range of the memory blocks allocated in step 210. It is understood that steps 210 and 215 would generally be performed as a “setup” phase or a “setup” sequence before the actual sequential data writing command is performed. For example, the “setup” phase would occur when the sequential range is established, which may occur at the factory, or may occur when a suitable management command (such as the SET SEQUENTIAL RANGES command discussed above) is issued.

The method 200 includes a step 220, in which data is written into the logically sequential range of the memory blocks in response to a first data write next request. The data is written starting with the first memory block and continuing sequentially in subsequent memory blocks within the range until the data write next request is completed.

The method 200 includes a step 225, in which the pointer is updated based on a last memory block in which data is written.

The method 200 includes a step 230, in which a completion status for the data write next request is returned upon a completion of the first data write next request. The completion status may be returned to a client and indicates the address of the first memory block in which data is written. It is understood that steps similar to the steps 220-230 would be performed each time a sequential data writing operation (e.g., one that uses the WRITE NEXT command) is processed. For example, a step 235 of the method describes a repeating of the steps 220-230 for a subsequent sequential data writing operation.

In step 235, additional data is written sequentially into the range of the memory blocks in response to a second data write next request. The additional data is written starting with a memory block that is addressed immediately after the previous last memory block (of step 225) and ending with a new last memory block. The first data write next request and the second data write next request may be sent from different clients. The pointer is updated again based on the new last memory block after the additional data is written. As discussed above, the step 235 (or the steps 220-230) may be repeated a plurality of times for subsequent sequential data write requests, such as a third, fourth, fifth, or sixth sequential data writing request, which may or may not be received from different clients.

It is understood that the method 200 may include additional steps that may be performed before, during, or after the steps 210-235. But for the sake of simplicity, these additional steps are not discussed in detail herein.

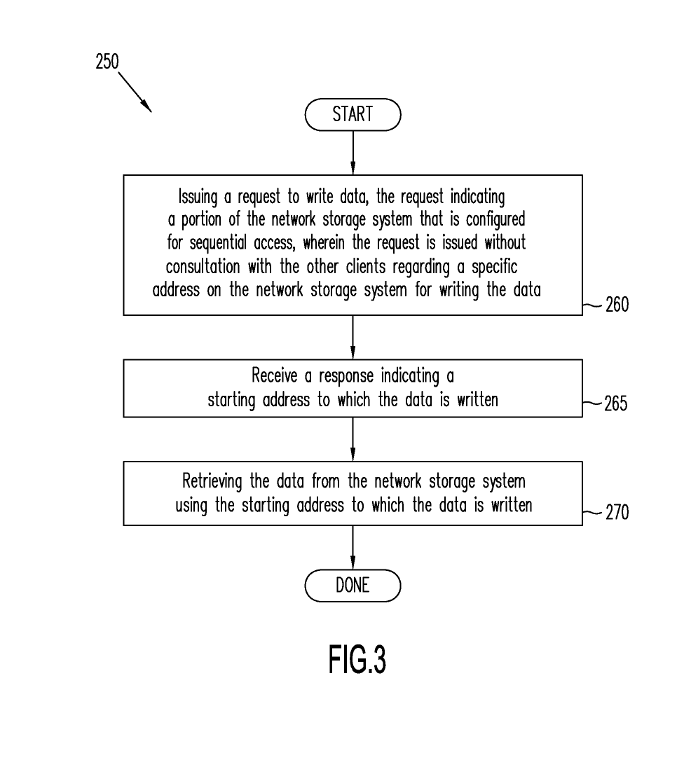

The method 200 of FIG. 2 is described from a perspective of a network storage system. In comparison, FIG. 3 is a method 250 for performing a sequential data writing command from the client's perspective according to various aspects of the present disclosure. In other words, one or more clients (such as the clients 110 of FIG. 1) perform the actions of the method 250. Once again, though a SCSI command, WRITE NEXT, is used as an example, it is understood that the scope of embodiments includes any sequential write request compatible with the concepts herein, for any protocol now known or later developed.

The method 250 includes a step 260, in which a request to write data is issued to a network storage system having random access storage media. As an example, the request is issued by a client, and the network storage system is shared by a plurality of other clients. The request includes asking data to be written to a portion of the network storage system that is configured for sequential access. In some embodiments, the request does not include a specific address to which the data should be written—rather, the device server determines a specific address within the portion that is configured for sequential access.

The request of step 260 is also issued without consultation with the other clients regarding a specific memory address on the network storage system to which the data should be written. If multiple clients are attempting to write data to the network storage system at approximately the same time—for example a second client has issued a sequential data write request before the sequential data write request from a first client has been processed—the network storage system will determine where (i.e., the specific memory addresses) the data from each client should be written. Each client issues the sequential data write request without needing to negotiate with other clients regarding which memory addresses should be used for writing the data. It is understood, however, that the clients may still communicate amongst themselves regarding other network issues such as communication bandwidth and etc.

The method 250 includes a step 265, in which a response is received from the network storage system, indicating a memory address to which the data is written. In some embodiments, the address corresponds to an address of a first memory block of the network storage system in which data is written. The method 250 includes a step 270, in which the data is retrieved using the address to which the data is written. In some embodiments, the data may be retrieved using a read command.

It is understood that the method 250 may include additional steps that may be performed before, during, or after the steps 260-270. For example, before the request to write data is issued in step 260, the client may ask the network storage system to reserve a portion of itself for sequential access. For the sake of simplicity, other additional steps are not discussed in detail herein.

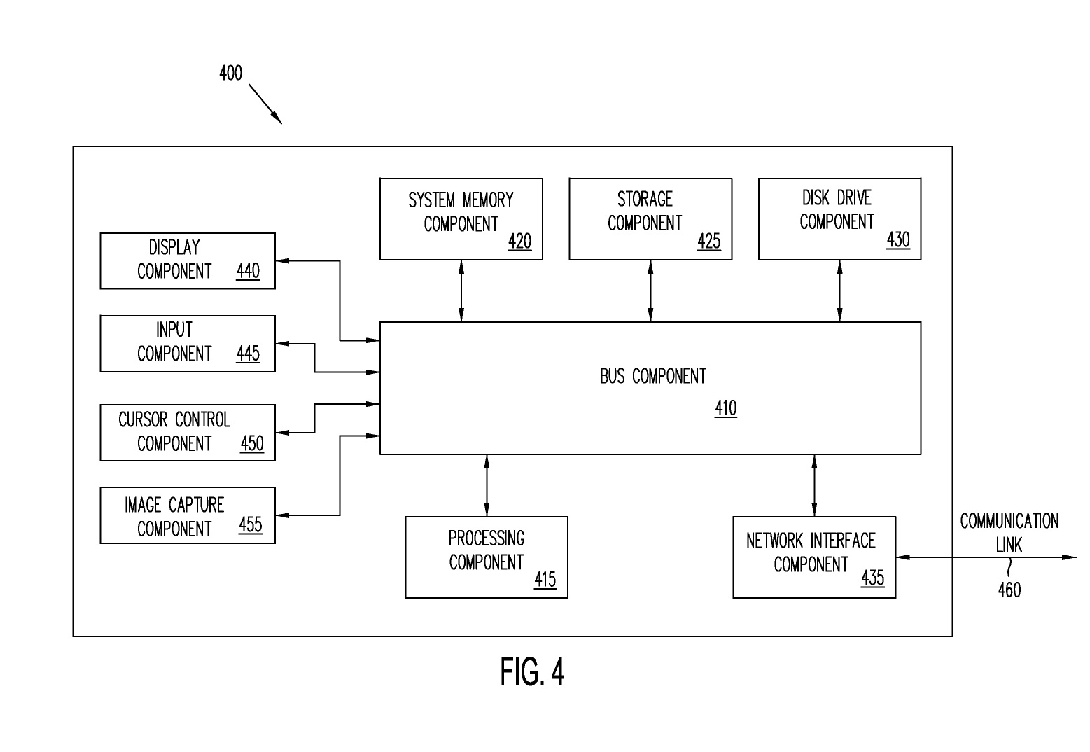

FIG. 4 is a block diagram of a computer system 400 suitable for implementing the methods and devices described herein, such as to implement the various method steps of the methods 200 and/or 250. In certain embodiments, the computer system 400 may be used to implement the server client 110 or the array 130 (including the logical units 150 or the device server 160) described above, or portions thereof.

In accordance with various embodiments of the present disclosure, the computer system 400 includes a bus component 410 or other suitable communication mechanisms for communicating information. The bus component 410 interconnects subsystems and components, for example, a processing component 415 (e.g., processor, micro-controller, digital signal processor (DSP), etc.), a system memory component 420 (e.g., Random Access Memory or RAM), a static storage component 425 (e.g., Read-Only Memory ROM), a disk drive component 430 (e.g., magnetic or optical), a network interface component 435 (e.g., a modem or an Ethernet card), a display component 440 (e.g., touch-screens, cathode ray tube (CRT) displays, or a liquid crystal display (LCD)), an input component 445 (e.g., keyboard or touch-sensitive components operable to detect a touch by a human body), a cursor control component 450 (e.g., mouse or trackball), and an image capture component 455 (e.g., analog or digital camera).

In accordance with various embodiments of the present disclosure, the computer system 400 performs specific operations by having the processor 415 execute one or more sequences of one or more instructions contained in the system memory component 420. Such instructions may be read into system memory component 420 from another computer readable medium, such as a static storage component 425 or a disk drive component 430. In other embodiments, hard-wired circuitry may be used in place of (or in combination with) software instructions to implement the present disclosure.

Logic may be encoded in a computer readable medium, which may refer to any medium that can store instructions to processor 415 for execution. Such medium may take one of many forms, including but not limited to, non-volatile media and volatile media. In some embodiments, the computer readable medium is non-transitory. For example, the computer readable medium is not a collection of transitory signals or signal carrier waves. In various implementations, non-volatile media includes optical or magnetic storage devices, such as disk drive component 430, and volatile media includes dynamic memory, such as system memory component 420.

Some common forms of computer readable media includes, for example, floppy storage device, flexible storage device, hard storage device, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is configured to read.

In various embodiments of the present disclosure, execution of instruction sequences to practice the various aspects of the present disclosure may be performed by the computer system 400. In various other embodiments of the present disclosure, a plurality of computer systems 400 coupled by a communication link 460 (e.g., a communications network, such as a LAN, WLAN, PTSN, and/or various other wired or wireless networks, including telecommunications, mobile, and cellular phone networks) may perform instruction sequences to practice the various aspects of the present disclosure in coordination with one another.

The computer system 400 may transmit and receive electronic messages, data, information and instructions, including one or more programs (i.e., application code) through the communication link 460 and a communication interface 435. Received program code may be executed by the processor 415 as received and/or stored in the disk drive component 430 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The various embodiments of the present disclosure offer advantages over other techniques. It is understood, however, that not all the advantages are disclosed herein, no advantage is required for all embodiments, and other embodiments may offer different advantages. For instance, the example sequential write operation discussed above allows for sequential access of a random access storage device. The client that wishes to write data need not manage where the data is written, because that task can be performed by the device server through the proper maintenance of a pointer. The device server updates the pointer after each sequential write operation, so that data from a subsequent WRITE NEXT operation can be automatically written to a proper sequential location on the storage device.

The example sequential write operation is particularly beneficial in a multi-client environment to a shared storage resource where a master server regulates access. Access to a shared storage resource by a plurality of clients is greatly simplified through the use of the disclosed sequential write command. Under conventional architectures, the clients would have to negotiate with other clients before data can be written into the shared storage device. The negotiation between clients would have been used in the conventional architecture, because otherwise multiple clients could attempt to try to write data to the same or overlapping regions of the shared storage device, thereby resulting in potential data loss. Thus, the negotiations are done so as to avoid overwriting and/or losing data. However, the negotiations place a burden on the clients to correctly manage the data writing process.

In comparison, the disclosed sequential write command allows each client to simply write its data into the shared storage device by issuing the sequential write command. The device server managing the shared storage device will put the data into the correct sequential memory location on the storage device by referring to the current “next write” pointer. The device server will also report back to the client the memory location on the storage device in which the data is written, so that the client can have access to that data later. The pointer is updated after each sequential write operation to ensure that the subsequent data will not be written to a previously-written memory location. In this manner, the data writing process is greatly simplified for the clients, and the integrity of the data writing operations is improved.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

As an example of implementing the sequential write command and the various management commands discussed above, the following Appendix provides an embodiment under a SCSI context. However, it is understood that various embodiments may implement the sequential write commands in any appropriate protocol now known or later developed.

### APPENDIX

This Appendix contains text that augments existing text in the SCSI SPC-4 and SCSI SBC-3 standards documents. For purposes of clarification, some of the abbreviations used below are defined as follows:
LBA: Logical Block Address
WSRRE range: Write Sequential Read Random (Erasable). This refers to a fixed set of logical blocks that exhibit WSRRE properties occupying contiguous LBAs on a single logical unit
VS: Vendor Specific
XOR: Exclusive-Or
HLSA: Hard Limit Sequential Access
VPD: Vital Product Data
SPC-4: SCSI Primary Command standard 4^{th} generation
SAM-4: SCSI Architecture Model standard 4^{th} generation
CDB: SCSI Command Data Block

Write Sequential Read Random-Erasable model. Direct access block devices may provide LBA ranges that do not provide full random access. LBA extents that do not provide full random access contain write sequential read random erasable (WSRRE) LBAs. A direct access block device may have multiple extents of WSRRE LBAs. For each WSRRE extent, the device server maintains a pointer that indicates the next sequential LBA in the extent that is to be written by the WRITE NEXT command.

WSRRE extents may be established during manufacturing or by using the SET SEQUENTIAL RANGES command. Support for the SET SEQUENTIAL RANGES command is optional. If WSRRE extents are supported, then the REPORT SEQUENTIAL RANGES command shall be supported.

If a device server supports both full random access LBAs and WSRRE LBA extents, then the LBAs in the full random access extent are from LBA zero through the value reported in the RETURNED LOGICAL BLOCK ADDRESS field of the READ CAPACITY parameter data. WSRRE LBAs shall not be reported in the RETURNED LOGICAL BLOCK ADDRESS field of the READ CAPACITY parameter data. WSRRE LBAs are from the LBA reported in the RETURNED LOGICAL BLOCK ADDRESS field of the READ CAPACITY parameter data plus one to the value in the WSRRE MAXIMUM LOGICAL BLOCK ADDRESS field of the READ CAPACITY parameter data.

For an LBA extent that provides WSRRE LBAs, the WRITE NEXT command performs sequential write operations from the first LBA in the extent to the last LBA in the extent. Each WRITE NEXT command adds the transfer length specified in the WRITE NEXT command to the next write pointer maintained by the device server for the WSRRE extent referenced by the WRITE NEXT command. Read operations may be performed on any LBA in the extent.

If the HLSA bit in the Sequential Access VPD page is set to one. then the device server shall restrict commands that request access to WSRRE LBAs as follows:
a) COMPARE AND WRITE. ORWRITE, UNMAP, WRITE. WRITE AND VERIFY, WRITE SAME, XDREAD, XDWRITE. XDWRITEREAD, and XPWRITE commands shall be terminated with CHECK CONDITION status, with the sense key set to ILLEGAL REQUEST and the additional sense code set to an appropriate value: and
b) READ and VERIFY commands that access LBAs that have not yet been written shall be terminated with CHECK CONDITION status, with the sense key set to ILLEGAL REQUEST and the additional sense code set to an appropriate value.

If the HLSA bit in the Sequential Access VPD page is set to zero, then the device server places no restrictions on commands that request access to WSRRE LBAs.

READ CAPACITY (16) parameter data. The READ CAPACITY (16) parameter data is defined in table 64 below. Anytime the READ CAPACITY (16) parameter data changes, the device server should establish a unit attention condition.

TABLE 64
READ CAPACITY (16) parameter data

| | Bit | | | | | | | |
|---|---|---|---|---|---|---|---|---|
| Byte | 7 | 6 | 5 | 4 | 3 | 2 | 1 | 0 |

| | | | |
|---|---|---|---|
| 0 | (MSB) | RETURNED LOGICAL BLOCK | |
| . . . | | ADDRESS | |
| 7 | | | (LSB) |
| 8 | (MSB) | LOGICAL BLOCK LENGTH IN BYTES | |
| . . . | | | |
| 11 | | | (LSB) |

| | | | |
|---|---|---|---|
| 12 | Reserved | P_TYPE | PROT_EN |

| | | |
|---|---|---|
| 13 | P_I_EXPONENT | LOGICAL BLOCKS PER |
| | | PHYSICAL BLOCK |
| | | EXPONENT |

| | | | | | |
|---|---|---|---|---|---|
| 14 | LBPME | LBPRZ | (MSB) | LOWEST ALIGNED | |
| | | | | LOGICAL BLOCK | |
| | | | | ADDRESS | |
| 15 | | | | | (LSB) |

| | | | |
|---|---|---|---|
| 16 | (MSB) | WSRRE MAXIMUM LOGICAL | |
| . . . | | BLOCK ADDRESS | |
| 23 | | | (LSB) |
| 24 | | Reserved | |
| . . . | | | |
| 31 | | | |

The RETURNED LOGICAL BLOCK ADDRESS field and LOGICAL BLOCK LENGTH IN BYTES field of the READ CAPACITY (16) parameter data are the same as in the READ CAPACITY (10) parameter data. The maximum value that shall be returned in the RETURNED LOGICAL BLOCK ADDRESS field is FFFF-FFFF-FFFF-FFFEh. The protection type (P_TYPE) field and the protection enable (PROT_EN) bit (see table 65 below) indicate the logical unit's current type of protection.

TABLE 65
P_TYPE field and PROT_EN bit

| P_TYPE | PROT_EN | Description |
|---|---|---|
| 000b to 111b | 0 | The logical unit is formatted to |
| | | type 0 protection |
| 000b | 1 | The logical unit is formatted to |
| | | type 1 protection |
| 001b | | The logical unit is formatted to |
| | | type 2 protection |
| 010b | | The logical unit is formatted to |
| | | type 3 protection |
| 011b to 111b | | Reserved |

The P_I_EXPONENT field may be used to determine the number of protection information intervals placed within each logical block. The number of protection information intervals is calculated as follows: number of protection information intervals=2^{(p}^{_{—}}^{i exponent)}, where: “p-i exponent” is the contents of the P_I_EXPONENT field. The LOGICAL BLOCKS PER PHYSICAL BLOCK EXPONENT field is defined in table 66.

TABLE 66
LOGICAL BLOCKS PER PHYSICAL
BLOCK EXPONENT FIELD

| Code | Description |
|---|---|
| 0 | One or more physical blocks per logical block^{a} |
| n > 0 | 2ⁿ logical blocks per physical block |

^{a}The number of physical blocks per logical block is not reported.

A logical block provisioning management enabled (LBPME) bit set to one indicates that the logical unit implements logical block provisioning management. An LBPME bit set to zero indicates that the logical unit is fully provisioned and does not implement logical block provisioning management.

A logical block provisioning read zeros (LBPRZ) bit set to one indicates that, for an unmapped LBA specified by a read operation, the device server sends user data with all bits set to zero to the data-in buffer. An LBPRZ bit set to zero indicates that, for an unmapped LBA specified by a read operation, the device server may send user data with all bits set to any value to the data-in buffer.

The LOWEST ALIGNED LOGICAL BLOCK ADDRESS field indicates the LBA of the first logical block that is located at the beginning of a physical block. (NOTE 1—The highest LBA that the lowest aligned logical block address field supports is 3FFFh (i.e., 16 383)).

The WSRRE MAXIMUM LOGICAL BLOCK ADDRESS field indicates the LBA of the last logical block in the last WSRRE extent of the direct-access block device.

SET SEQUENTIAL RANGES command. The Set SEQUENTIAL RANGES command (see table X.1 below) requests that the device server establish the sequential access characteristics for only the specified LBAs.

TABLE X.1
SET SEQUENTIAL RANGES command

| | Bit | | | | | | | |
|---|---|---|---|---|---|---|---|---|
| Byte | 7 | 6 | 5 | 4 | 3 | 2 | 1 | 0 |

| 0 | OPERATION CODE (xxh) | |
|---|---|---|
| 1 | Reserved | SERVICE ACTION (yyh) |

| | | | |
|---|---|---|---|
| 2 | | Reserved | |
| . . . | | | |
| 6 | | | |
| 7 | (MSB) | PARAMETER LIST LENGTH | |
| 8 | | | (LSB) |

| | |
|---|---|
| 9 | CONTROL |

The OPERATION CODE field is defined in SPC-4 and shall be set to the value shown in table X.1 for the SET SEQUENTIAL RANGES command. The SERVICE ACTION field is defined in SPC-4 and shall be set to the value shown in table X.1 for the SET SEQUENTIAL RANGES command. The PARAMETER LIST LENGTH field specifies the length in bytes of the parameter data that shall be sent from the application client to the device server. A PARAMETER LIST LENGTH set to zero specifies that no data shall be sent. This shall not be considered an error, and no changes to WSRRE ranges shall occur. The contents of the CONTROL byte are defined in SAM-4.

Set sequential access parameter list overview. The set sequential access parameter list contains the data available to be transferred from the application client data-out buffer. The set sequential access parameter list includes a parameter list header and zero or more range descriptors to be processed by the device server.

TABLE X.2
Set sequential access parameter list

| | Bit | | | | | | | |
|---|---|---|---|---|---|---|---|---|
| Byte | 7 | 6 | 5 | 4 | 3 | 2 | 1 | 0 |

| | | | |
|---|---|---|---|
| 0 | (MSB) | PARAMETER DATA LENGTH (n − 1) | |
| 1 | | | (LSB) |

| | |
|---|---|
| 2 | Reserved |
| 3 | Reserved |

Sequential Range descriptors

| | |
|---|---|
| 4 | Sequential Range descriptor [first] |
| . . . | |
| <?> | |

.
.
.

| | |
|---|---|
| <?> | Sequential Range descriptor (last] |
| . . . | |
| n | |

The PARAMETER DATA LENGTH field specifies the length in bytes of the following data that is available to be transferred from the data-out buffer. The parameter data length does not include the number of bytes in the PARAMETER DATA LENGTH field. If the PARAMETER DATA LENGTH field is set to zero, then no range descriptors are included in the parameter list.

Each sequential range descriptor specifies one range of LBAs and the next pointer to be set for that range.

If all sequential range descriptors are processed without error, GOOD status shall be returned. If none of the sequential range descriptors have been set, the command shall be terminated with CHECK CONDITION status with the sense key set to ILLEGAL REQUEST and the additional sense code set to a value that reflects the error encountered.

If some but not all of the WSRRE ranges in some of the range descriptors have been set, the command shall be terminated with CHECK CONDITION status with the sense key set to ABORTED COMMAND, the additional sense code set to a value that reflects the error encountered, the SKSV bit (see SPC-4) shall be set to one, and the SENSE KEY SPECIFIC field shall be set to provide information that helps locate the error encountered.

If an SET SEQUENTIAL RANGES command encounters an error that causes the command to be terminated in a way that results in the logical unit being configured as if no sequential access ranges had ever been set, then the command shall be terminated with CHECK CONDITION status with the sense key set to ILLEGAL REQUEST, the additional sense code set to a value that reflects the error encountered, the SKSV bit (see SPC-4) shall be set to one, and the SENSE KEY SPECIFIC field shall be set to provide information that helps locate the error encountered.

Sequential range descriptor format overview. Sequential range descriptors. The sequential range descriptor (see table X.3 below) is used to set and report sequential ranges.

TABLE X.3
Sequential range descriptor

| | Bit | | | | | | | |
|---|---|---|---|---|---|---|---|---|
| Byte | 7 | 6 | 5 | 4 | 3 | 2 | 1 | 0 |

| | | | |
|---|---|---|---|
| 0 | (MSB) | LOGICAL BLOCK ADDRESS | |
| . . . | | | (LSB) |
| 7 | | | |
| 8 | (MSB) | NUMBER OF LOGICAL BLOCKS | |
| . . . | | | |
| 11 | | | (LSB) |
| 12 | | WRITE NEXT POINTER | |
| . . . | | | |
| 19 | | | |
| 20 | | Reserved | |
| . . . | | | |
| 23 | | | |

The LOGICAL BLOCK ADDRESS field specifies the first (i.e. lowest numbered) LBA of a WSRRE range. The NUMBER OF LOGICAL BLOCKS field specifies the number of LBAs in the WSRRE range beginning with the LBA specified by the LOGICAL BLOCK ADDRESS field. If the LBA specified by the LOGICAL CLOCK ADDRESS field plus the number of logical blocks exceeds the capacity of the medium, then the device server shall:
a) not modify any LBAs in the specified range during the processing of this sequential range descriptor; and
b) terminate the command with CHECK CONDITION status with the sense key set to ILLEGAL REQUEST and the additional sense code set to LOGICAL BLOCK ADDRESS OUT OF RANGE.

If the NUMBER OF LOGICAL BLOCKS field is set to zero, then the device server shall not modify any of the LBAs in the specified range during the processing of this sequential range descriptor. This shall not be considered an error.

If larger than VPD page maximum value—error. If smaller than VPD page minimum—error. Deal with granularity and alignment requirements as well.

The WRITE NEXT POINTER field specifies the value to be set in the device server maintained pointer that indicates the next sequential LBA in the extent that is to be written by the WRITE NEXT command.

Report Sequential Ranges command overview. The REPORT SEQUENTIAL RANGES command (see table X.4 below) requests that the device server return the WSRRE extents that are associated with a specified set of LBAs.

TABLE X.4
REPORT SEQUENTIAL RANGES command

| | Bit | | | | | | | |
|---|---|---|---|---|---|---|---|---|
| Byte | 7 | 6 | 5 | 4 | 3 | 2 | 1 | 0 |

| 0 | OPERATION CODE (xxh) | |
|---|---|---|
| 1 | Reserved | SERVICE ACTION (yyh) |

| | | | |
|---|---|---|---|
| 2 | (MSB) | LOGICAL BLOCK ADDRESS | |
| . . . | | | |
| 9 | | | (LSB) |
| 10 | (MSB | ALLOCATION LENGTH | |
| . . . | | | |
| 13 | | | (LSB) |

| | |
|---|---|
| 14 | Reserved |
| 15 | Control |

The OPERATION CODE field is defined in SPC-4 and shall be set to the value shown in table X.4 for the REPORT SEQUENTIAL RANGES command. The SERVICE ACTION field is defined in SPC-4 and shall be set to the value shown in table X.4 for the REPORT SEQUENTIAL RANGES command. The LOGICAL BLOCK ADDRESS field specifies the first LBA for which sequential access information shall be returned.

The ALLOCATION LENGTH field is defined in SPC-4. The device server may return less data than specified in the allocation length. If sufficient information to satisfy the requirement of the application client is not returned in a single REPORT SEQUENTIAL RANGES parameter data buffer, then the application client may issue additional REPORT SEQUENTIAL RANGES commands with different starting logical block address values to retrieve additional information. If the ALLOCATION LENGTH field is set to zero, then no information shall be transferred to the data-in buffer. This condition shall not be considered an error. The contents of the CONTROL byte are defined in SAM-4.

REPORT SEQUENTIAL RANGES parameter data. The parameter list for the REPORT SEQUENTIAL RANGES command (see table X.5) contains an eight-byte header followed by one or more sequential range descriptors.

TABLE X.5
REPORT SEQUENTIAL RANGES parameter data

| | Bit | | | | | | | |
|---|---|---|---|---|---|---|---|---|
| Byte | 7 | 6 | 5 | 4 | 3 | 2 | 1 | 0 |

| | | | |
|---|---|---|---|
| 0 | (MSB) | PARAMETER DATA LENGTH (n − 3) | |
| . . . | | | |
| 3 | | | (LSB) |
| 4 | | Reserved | |
| . . . | | | |
| 7 | | | |

Sequential range descriptors

| | |
|---|---|
| 8 | Sequential range descriptor [first] (see 6.2.2.2) |
| . . . | |
| <?> | |

.
.
.

| | |
|---|---|
| <?> | Sequential range descriptor [last] |
| | (see 6.2.2.2) |
| . . . | |
| n | |

The PARAMETER DATA LENGTH field indicates the number of bytes of parameter data that follow. The relationship between the PARAMETER DATA LENGTH field and the ALLOCATION LENGTH field in the CDB is defined in SPC-4. Each sequential range descriptor indicates the WSRRE range to which one or more LBAs are associated.

WRITE NEXT command. The WRITE NEXT command (see table X.6) requests that the device server write sequential contiguous LBAs starting at the LBA indicated by the write next pointer maintained by the device for the SWRRE extent that contains the specified LBA. The device server shall process the WRITE NEXT command as follows:
1) use the specified L BA to determine the WSRRE range;
2) retrieve the write next pointer for the WSRRE range determined in step 1;
3) add the transfer length to the write next pointer for the WSRRE range determined in step 1;
4) write sequential LBAs starting at the LBA determined in step 2;
5) complete the command with sense data that contains the LBA retrieved in step 2 in the COMMAND-SPECIFIC INFORMATION field.

TABLE X.6
WRITE NEXT command

| | Bit | | | | | | | |
|---|---|---|---|---|---|---|---|---|
| Byte | 7 | 6 | 5 | 4 | 3 | 2 | 1 | 0 |

| 0 | OPERATION CODE (xxh) | |
|---|---|---|
| 1 | WRPROTECT | SERVICE ACTION (yyh) |

| | | | |
|---|---|---|---|
| 2 | (MSB) | SUGGEST LBA | |
| . . . | | | |
| 9 | | | (LSB) |
| 10 | (MSB) | TRANSFER LENGTH | |
| . . . | | | |
| 13 | | | (LSB) |

| | | |
|---|---|---|
| 14 | Reserved | GROUP NUMBER |

| | |
|---|---|
| 15 | CONTROL |

The OPERATION CODE field is defined in SPC-4 and shall be set to the value shown in table X.6 for the WRITE NEXT command. The SERVICE ACTION field is defined in SPC-4 and shall be set to the value shown in table X.6 for the WRITE NEXT command.

The SUGGESTED LBA field specifies the LBA used to determine the WSRRE range that is to be accessed by this command. If the specified LBA exceeds the capacity of the medium, then the device server shall terminate the command with CHECK CONDITION status with the sense key set to ILLEGAL REQUEST and the additional sense code set to LOGICAL BLOCK ADDRESS OUT OF RANGE. If the specified LBA is not in a WSRRE range, then the device server shall terminate the command with CHECK CONDITION status with the sense key set to ILLEGAL REQUEST and the additional sense code set to yyy.

The TRANSFER LENGTH fields specifies the number of contiguous logical blocks of data that are available to be transferred from the Data-Out Buffer and written, starting with the logical block indicated in the write next pointer maintained by the device server for the WSRRE region that contains the specified logical block address. A TRANSFERRED LENGTH field set to zero specifies that no logical blocks shall be written. This condition shall not be considered an error. If the LBA where the write operation begins plus the transfer length exceeds the capacity of the medium, then the device server shall terminate the command with CHECK CONDITION status with the sense key set to ILLEGAL REQUEST and the additional sense code set to LOGICAL BLOCK ADDRESS OUT OF RANGE. The TRANSFER LENGTH field is constrained by the MAXIMUM TRANSFER LENGTH field in the Block Limits VPD page. The contents of the CONTROL byte are defined in SAM-4.

Vital product data (VPD) parameters. VPD parameters overview. This subclause defines the VPD pages used only with direct-access block devices. See SPC-4 for VPD pages used with all device types. The VPD pages and their corresponding page codes specific to direct-access block devices are defined in table 182 below.

TABLE 182
Direct-access block device VPD page codes

| | | | Support |
|---|---|---|---|
| VPD page name | Page code ^{a} | Reference | requirements |
| Block Device Characteristics | B1h | 6.5.2 | Optional |
| VPD page | | | |
| Block Limits VPD page | B0h | 6.5.3 | Optional |
| Logical Block Provisioning | B2h | 6.5.4 | Optional |
| VPD page | | | |
| Referrals VPD page | B3h | 6.5.5 | Optional |
| Sequential Access VPD page | TBD | 6.5.x | Optional |
| Reserved for this standard | B4h to BFh | | |

^{a} All page code and subpage code combinations for direct-access block devices not shown in this table are reserved.

Sequential Access VPD page (see Table X.8). The Sequential Access VPD page provides the application client with the means to obtain certain operating parameters of the logical unit.

TABLE X.8
Sequential Access VPD page

| | Bit | | | | | | | |
|---|---|---|---|---|---|---|---|---|
| Byte | 7 | 6 | 5 | 4 | 3 | 2 | 1 | 0 |

| | | |
|---|---|---|
| 0 | PERIPHERAL QUALIFIER | PERIPHERAL DEVICE TYPE |

| 1 | PAGE CODE (xxh) | | | |
|---|---|---|---|---|
| 2 | (MSB) | PAGE LENGTH (xxxxxh) | | |
| 3 | | | | (LSB) |
| 4 | Reserved | | | HLSA |
| 5 | Reserved | | | |
| 6 | Reserved | | | |
| 7 | | | | |
| | UGAVALID | (MSB) | ALIGNMENT | |
| . . . | | | | |
| | | | | (LSB) |

| | | | |
|---|---|---|---|
| | (MSB) | LIMIT xxx | |
| . . . | | | |
| | | | (LSB) |
| . . . | | Reserved | |

The PERIPHERAL QUALIFIER field and the PERIPHERAL DEVICE TYPE field are defined in SPC-4. The PAGE CODE field and PAGE LENGTH field are defined in SPC-4 and shall be set to the values shown in table X.8. The hard limit sequential access (HLSA) bit indicates how commands accessing WSRRE LBAs are handled. An HLSA bit set to one indicates that commands that access WSRRE LBAs shall be restricted as described in 4.x. An HLSA bit set to zero indicates there are no restrictions on command processing.

What is claimed is:

1. A method, comprising:
allocating a logically sequential range of random access memory blocks for sequential access;
initializing a pointer with an address of a first memory block of the logically sequential range of memory blocks;
writing, in response to a data write next request, data into the logically sequential range of memory blocks, starting with the first memory block and continuing sequentially in subsequent memory blocks within the range until the data write next request is completed; and
thereafter updating the pointer based on a last memory block in which data is written.

2. The method of claim 1, further comprising: returning, upon a completion of the data write next request, a completion status for the data write next request, wherein the completion status indicates the address of the first memory block in which data is written.

3. The method of claim 1, wherein the random access memory blocks reside on a logical unit of a storage device.

4. The method of claim 3, wherein the allocating is performed by a device server in response to an allocation request from a client of a network storage array, wherein the device server and the storage device are components of the network storage array.

5. The method of claim 3, wherein the allocating is implemented at a time when the storage device is physically fabricated.

6. The method of claim 3, wherein the allocating is performed at a time when the logical unit is created by a management application from a client of a network storage array.

7. The method of claim 3, wherein the data write next request comprises a first data write next request, and wherein the last memory block in which the data is written is known as a previous last memory block;
and further comprising: writing, in response to a second data write next request, additional data sequentially into the range of the memory blocks, starting with a memory block that is addressed immediately after the previous last memory block and ending with a new last memory block.

8. The method of claim 7, further comprising: updating the pointer again based on the new last memory block after the writing the additional data.

9. The method of claim 7, wherein the first data write next request and the second data write next request are sent from different clients of a network storage array.

10. An apparatus comprising a non-transitory, tangible machine-readable storage medium storing a computer program, wherein the computer program contains machine-readable instructions that when executed electronically by processors, perform:
reserving a group of logically contiguous random access memory blocks on a storage device for sequential access;
assigning, to a pointer, an address of a first memory block of the group of memory blocks;
performing a first data write next operation that includes writing data into a first subset of the memory blocks, starting with the first memory block and continuing sequentially until all the data has been written;
assigning, to the pointer, an address of a second memory block that is sequentially immediately after a last memory block of the first subset;
performing a second data write next operation that includes writing additional data into a second subset of the memory blocks, starting with the second memory block and continuing sequentially until all the additional data has been written; and
assigning, to the pointer, an address of a third memory block that is sequentially immediately after a last memory block of the second subset.

11. The apparatus of claim 10, wherein the computer program further comprises instructions for:
returning, upon a completion of the first data write next operation, a first completion status for the first data write next operation; and
returning, upon a completion of the second data write next operation, a second completion status for the second data write next operation;
wherein the first completion status and the second completion status include the addresses of the first memory block and the second memory block, respectively.

12. The apparatus of claim 10, wherein the instructions for the reserving comprise instructions for reserving the group of the logically contiguous random access memory blocks for sequential access in response to a request from a client.

13. The apparatus of claim 10, wherein:
the first data write next operation is performed in response to a first write next command from a first client; and
the second data write next operation is performed in response to a second write next command from a second client.

14. A network storage system, comprising:
one or more storage devices that each contain a plurality of memory blocks, the one or more storage devices being represented by a logical unit; and
a device server that manages data access to a logical unit, the device server executing code to perform the following operations:
setting a pointer to point to an address of a first memory block of a logically contiguous subset of the memory blocks, wherein the subset of the memory blocks has been designated for sequential access;
writing, in response to a write next command issued by a client communicatively coupled to the network storage system, an amount of data into the subset of memory blocks, starting with the first memory block and continuing sequentially until the amount of data has been written in its entirety; and
updating the pointer to point to an address of a memory block that comes logically immediately after a last memory block in which the amount of data is written.

15. The network storage system of claim 14, wherein the memory blocks are random access memory blocks, and wherein the subset of the memory blocks is designated for sequential access during a manufacturing of the one or more storage devices.

16. The network storage system of claim 14, wherein the memory blocks are random access memory blocks, and wherein the subset of the memory blocks is designated for sequential access by a management application from the client or by the device server in response to a designation request from the client.

17. The network storage system of claim 14, wherein the device server executes code to further perform: reporting, after the writing, to the client an address of the first memory block.

18. The network storage system of claim 14, wherein the device server executes code to further perform: writing, after a completion of the write next command and in response to a further write next command, an amount of additional data into the subset of memory blocks, starting with the memory block pointed to by the pointer and continuing sequentially until the amount of additional data has been written in its entirety.

19. The network storage system of claim 18, wherein the device server executes code to further perform: updating the pointer to point to an address of a memory block that comes logically immediately after a last memory block in which the additional data is written.

20. The network storage system of claim 18, wherein the further write next command is issued by a further client communicatively coupled to the network storage system.
